(19) United States
(12) Patent Application Publication
(10) Pub. No.: US 2015/0060150 A1
(43) Pub. Date: Mar. 5, 2015

(54) MASS BALANCING DRILL BIT DESIGN METHODS AND MANUFACTURING

(71) Applicant: HALLIBURTON ENERGY SERVICES, INC, Houston, TX (US)

(72) Inventors: Nuno Da Silva, Brussels (BE); Stephan Regnard, Brussels (BE); Najib Laatiaoui, Bordeaux (FR)

(73) Assignee: HALLIBURTON ENERGY SERVICES, INC., Houston, TX (US)

(21) Appl. No.: 14/367,032

(22) PCT Filed: Sep. 3, 2013
(86) PCT No.: PCT/US13/57774

§ 371 Date: Jun. 19, 2014

(51) Int. Cl. E21B 10/42; E21B 10/55; G06F 17/50

(52) U.S. Cl. CPC E21B 10/42; G06F 17/50; E21B 10/55
USPC 175/428; 703/1

(57) ABSTRACT

One disclosed method includes generating a design model for a drill bit, the design model including one or more blades and channels, determining a rotational axis of the design model, dividing the design model into a plurality of unitary volume parallelepipedic elements distributed over at least a portion of the design model, determining a material density and mass of each unitary volume parallelepipedic element and using the material density and mass of each unitary volume parallelepipedic element to calculate a total mass of the design model, calculating a location of an inertia axis of the design model, determining a resulting centrifugal force of the design model upon applying a given angular velocity to the design model and using at least a portion of the total mass and the inertia axis, and modifying the design model to compensate for the resulting centrifugal force and thereby generating a modified design model.

### BACKGROUND

The present disclosure relates to drill bits used in drilling boreholes in subterranean formations and, more particularly, to methods of calculating the center of mass position during drill bit design such that a mass balanced drill bit may be manufactured.

In most drilling methods, energy supplied to a drill bit may be transmitted through the drill string, such as by rotating the drill string to rotate the drill bit. As the drill bit rotates in engagement with the formation, it grinds and/or crushes rock to create a borehole. “Diamond-impregnated” drill bits are often selected for cutting hard formations and/or to increase the durability of the drill bit. The cutting structure of a diamond-impregnated bit may include abrasive particles, such as diamonds embedded within metallic portions of the drill bit. The cutting structures may be secured to a matrix bit body containing a powdered metal or a hard particulate material, such as tungsten carbide. The powdered metal or hard particulate material is infiltrated with a binder, such as a copper alloy. As the diamond-impregnated bit grinds and cuts the rock of the formation, the metal of the matrix bit body gradually wears and erodes, exposing new layers of abrasive particles (e.g., diamond crystals) so that fresh or sharp abrasive particles are always available on the cutting surface for the cutting process.

Unbalances in the mass or cutting forces of the drill bit can potentially initiate unwanted vibrations in the drill bit. The energy level of drill bit vibrations will typically increase with increasing rotational speed (measured in RPMs) of the drill string and the drill bit. Diamond-impregnated drill bits are usually run on motors or turbines that can exhibit rotational speeds ranging upwards of 1800 RPM, but typically operating between about 600 RPM and about 1200 RPM. Any unbalanced mass on such diamond-impregnated drill bits rotating at such speeds can create large unbalanced side forces on the drill bit that can potentially develop into drill bit vibration. Excessive drill bit vibrations can result in damage to the drill bit and/or damage to other drill components, such as a bottom hole assembly associated with the drill bit.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, as will occur to those skilled in the art and having the benefit of this disclosure.

FIG. 1 illustrates an exemplary well system that may employ a drill bit incorporating teachings of the present disclosure.

FIGS. 2A and 2B depict a rotating body and the effects of the mass of the rotating body with respect to the rotational axis and its inertia axis.

FIGS. 3A and 3B depict isometric and end views, respectively, of an exemplary drill bit that may incorporate the teachings of the present disclosure.

FIG. 4 illustrates a virtual design model of a portion of the drill bit of FIGS. 3A and 3B as laid out in a plot, according to one or more embodiments.

FIG. 5 depicts a plan view of the plot of FIG. 4 and further provides an enlarged view of a portion of the design model of the drill bit.

FIG. 5A illustrates a partial cross-sectional view of an exemplary matrix body bit head, according to one or more embodiments.

FIGS. 6A and 6B depict an exemplary mass balancing solution, according to one or more embodiments.

FIG. 7 is a schematic diagram of a method of manufacturing a mass-balanced drill bit, according to one or more embodiments.

### DETAILED DESCRIPTION

The present disclosure relates to drill bits used in drilling boreholes in subterranean formations and, more particularly, to methods of calculating the center of mass position during drill bit design such that a mass balanced drill bit may be manufactured.

Disclosed are methods of mass balancing drill bits, such as impregnated drill bits. The methods described herein proceed by determining imbalances in mass force and moment for given rotational speeds such that mass-balanced drill bits may be manufactured that substantially compensate for any mass imbalance. Briefly, the mass imbalance may be determined by considering the inertia axis offset of the drill bit with respect to the geometric rotational axis of the drill bit. The determined mass imbalance may then be compensated for or otherwise corrected by undertaking one or more mass balancing solutions. Such mass balancing solutions include, but are not limited to, optimizing blade geometries of the drill bit, optimizing the angular positions of one or more of the drill bit blades, optimizing the blank geometry of the drill bit, distributing different materials within the blades and/or the body of the drill bit, and adding specific mass elements to the blades and/or bit body during or after infiltration. The methods described herein may prove advantageous in modifying drill bit designs such that the center of mass of the drill bit is brought into alignment (or substantial alignment) with the geometric rotational axis of the drill bit, thereby reducing or eliminating unwanted vibration generation in a resulting manufactured drill bit.

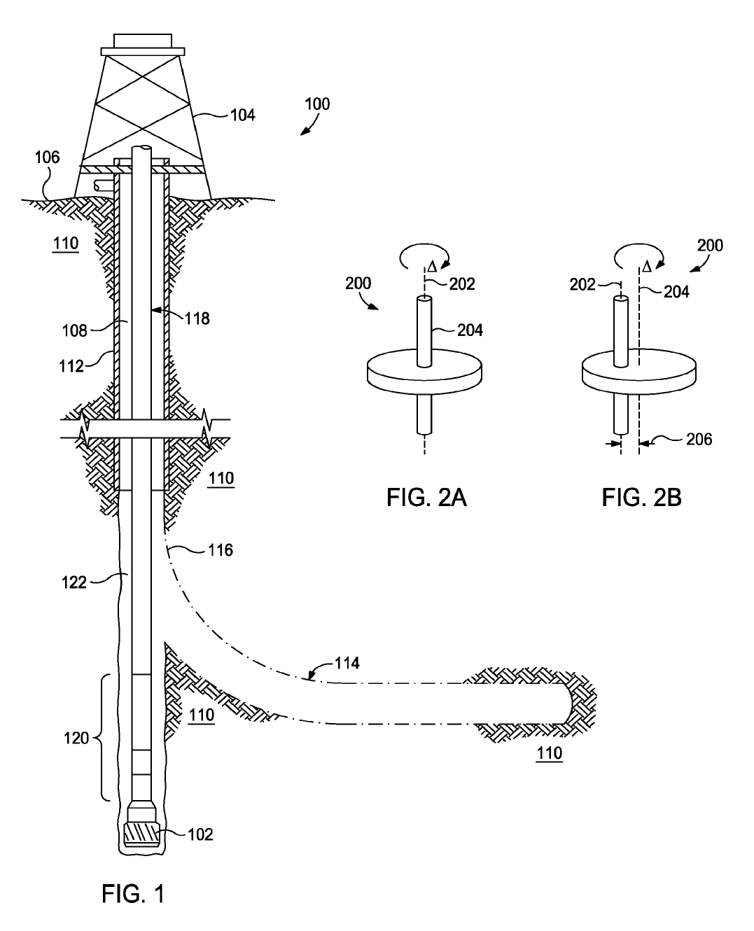

Referring to FIG. 1, illustrated is an exemplary well system 100 that may employ a drill bit 102 incorporating teachings of the present disclosure, according to one or more embodiments. While the present disclosure focuses its discussion primarily on impregnated drill bits, those skilled in the art will readily appreciate that the teachings discussed herein may equally be applied to the design and manufacture of other downhole drilling tools such as, but not limited to, core bits, reamers, fixed cutter drill bits, matrix and steel body polycrystalline diamond compact (PDC) drill bits, without departing from the scope of the disclosure.

As illustrated, the well system 100 may include a drilling rig 104 that is positioned on the Earth's surface 106 and extends over and around a wellbore 108 that penetrates one or more subterranean formations 110. While the well system 100 is depicted as a land-based operation, it will be appreciated that the principles of the present disclosure could equally be applied to drilling equipment associated with offshore platforms, drill ships, semi-submersibles and drilling barges, as generally known in the art.

The wellbore 108 may be drilled into the subterranean formations 110 and may extend in a substantially vertical direction away from the surface 106. In some embodiments, the wellbore 108 may be completed by cementing a casing string 112 therein along all or a portion thereof. Portions of the wellbore 108 that do not include casing 112 may be characterized as “open hole” portions of the wellbore 108. In some applications, it may be desirable to form a lateral wellbore 114 that deviates from the wellbore 108 stemming from a kickoff point 116 and thereafter transitioning into a substantially horizontal or deviated wellbore section.

The drill bit 102 may be extended into the wellbore 108 (or the lateral wellbore 114) as coupled to the end of a drill string 118 extended from the drilling rig 104. The drill string 118 may have a bottom hole assembly (BHA) 120 arranged at or near the drill bit 102. The BHA 120 may be formed from a wide variety of tools and components including, but not limited to, drill collars, rotary steering tools, directional drilling tools, downhole drilling motors, various sensors and gauges, and the like. The number of tools and components associated with the BHA 120 may depend upon anticipated downhole drilling conditions and the type of borehole that is intended to be formed by the drill string 118 and the drill bit 102.

In operation, a drilling fluid or “mud” may be pumped from the drilling rig 104 at the surface 106 and through the drill string 118 to the attached drill bit 102. The drilling fluid may be ejected from the drill bit 102 via a plurality of nozzles arranged therein and then circulated back to the surface 106 via the annulus 122 defined between the drill string 118 and the inside diameter of the wellbore 108. The drilling fluid may perform several functions, including cleaning associated cutting elements and cutting structures on the drill bit 102, cooling the drill bit 102, and flushing formation cuttings and other downhole debris upward to the surface 106 and into an adjacent retention pit (not shown). Various types of drilling equipment such as a rotary table, mud pumps, and mud tanks (not shown) may also be located at the drilling rig 104 to help facilitate this operation.

As the drill bit operates in rotation, mass imbalances of the drill bit 102 may produce large imbalanced side forces that may potentially generate vibrations in the drill bit 102. Such vibrations may propagate to the BHA 120 and eventually extend through the entire drill string 118, ending typically in damage to the drill bit 102 and/or damage to the BHA 120. According to embodiments of the present disclosure, mass imbalances of the drill bit 102 may be corrected during the design phase of the drill bit 102 such that a certified mass-balanced drill bit may be manufactured that is less susceptible to vibration generation. In particular, the methods described herein may include determining the location of the center of mass for a drill bit design and modifying the drill bit design such that the center of mass aligns or substantially aligns with the geometric rotational axis of the drill bit design.

Referring to FIGS. 2A and 2B, illustrated is a rotating body 200 having a rigid geometry. For illustrative purposes, the rotating body 200 may generally represent the drill bit 102 of FIG. 1 or any other drill bit used to form a borehole or wellbore. The rotating body 200 naturally exhibits a rotational axis 202 about which the geometry of the rotating body 200 rotates. When the mass of the rotating body 200 is taken into consideration, the rotating body 200 may exhibit a center of mass axis or inertia axis 204 about which the distributed mass of the rotating body 200 tends to naturally rotate. When the rotational axis 202 and the inertia axis 204 are substantially aligned, such as is depicted in FIG. 2A, the rotating body 200 is considered dynamically balanced and resulting centrifugal forces acting on the rotating body 200 are generally imperceptible. However, when the rotational axis 202 and the inertia axis 204 are misaligned, such as is depicted in FIG. 2B, the rotating body 200 is unbalanced and vibration, noise, and stresses on the rotating body 200 may result.

The radial distance from the rotational axis 202 of the rotating body 200 to the inertia axis 204 may be referred to herein as the inertia axis offset 206, and can be measured to help determine the resulting centrifugal force acting on the rotating body 200 during rotation. In particular, when the mass of the rotating body 200 is imbalanced, the resulting centrifugal force F generated by the rotating body 200 while rotating can be calculated using the following equation:

F=mRω² Equation (1)

where m is the mass of the rotating body 200, R is the radial position of the inertia axis offset 206, and ω is the angular velocity or speed of rotation of the rotating body 200. The result to Equation (1) provides the magnitude of centrifugal force F expected to be experienced by the rotating body 200 in rotational operation. According to the methods described herein, the design of the rotating body 200 (i.e., the drill bit 102 of FIG. 1 or any other drill bit) may be modified such that the rotational axis 202 and the inertia axis 204 become aligned. Doing so may reduce the likelihood of vibrations caused by mass imbalances and substantially enhance the stability of the drill bit 102 in operation in downhole environments. This may also enhance wear resistance, impact resistance, and stability and/or steerability of manufactured drill bits.

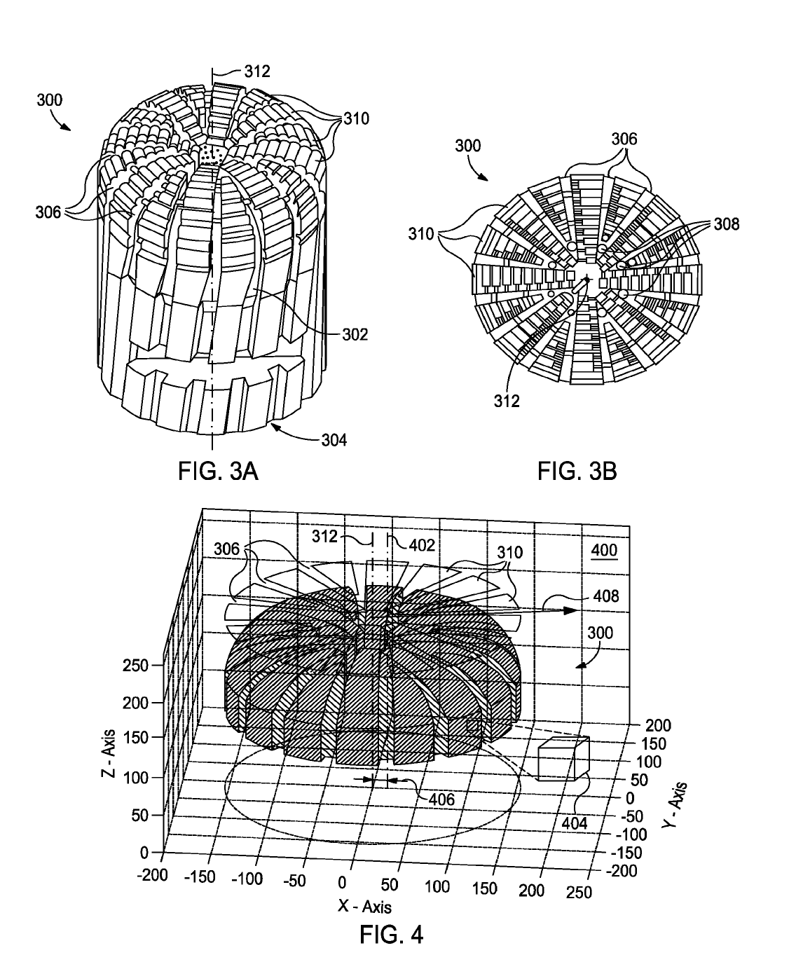

Referring now to FIGS. 3A and 3B, with continued reference to FIGS. 1 and 2A-2B, illustrated are isometric and end views, respectively, of an exemplary drill bit 300. The drill bit 300 may be substantially similar to the drill bit 102 of FIG. 1 and referenced in FIGS. 2A-2B. The drill bit 300 may include a bit body 302 and a threaded connection (not shown) at one end 304 configured to couple the drill bit 300 to the BHA 120 (FIG. 1). The drill bit 300 may also include a plurality of channels 306 or “junk slots” that are formed or otherwise milled into the bit body 302 during manufacturing. The channels 306 provide fluid passages for the flow of drilling fluids into and out of the wellbore 108 (FIG. 1). The drilling fluid may be ejected from the drill bit 300 via a plurality of nozzles or ports 308 (FIG. 3B) disposed proximate the channels 306.

The channels 306 may define or otherwise divide a plurality of blades 310 that may be formed or defined in any shape known in the art. While the blades 310 in FIGS. 3A-3B are shown as generally straight (i.e., extending substantially orthogonal from a rotational axis 312), such a configuration is not meant to limit the scope of the disclosure. Instead, those skilled in the art will readily appreciate that the blades 310 may alternatively be formed in other shapes and configurations, without departing from the scope of the disclosure. Moreover, in the illustrated embodiment, sixteen blades 310 are depicted, but it will be appreciated that more or less than sixteen blades 310 may be employed, depending on the application.

The drill bit 300 may be manufactured from a base metal matrix material. In particular, the drill bit 300 may be formed through a powder metallurgy method in which a cutting structure may be formed through various mixing processes of abrasive particles and metal bonding material to form an impregnated drill bit. The abrasive particles may be located on limited regions of the drill bit 300, but may also be located throughout the entire outer surface of the drill bit 300. In some embodiments, the drill bit 300 may also include abrasive inserts (not shown), which may also include abrasive particles, such as synthetic or natural diamond, boron nitride, or any other hard or super-hard material. The drill bit 300 is shown and described as an impregnated drill bit, which is run more often at higher rotational velocities than other types of drill bits, such as core bits, reamers, fixed cutter drill bits, and PDC drill bits. However, the teachings of the present disclosure are equally applicable to these other types of drill bits.

During the design stage for the drill bit 300, various design parameters for the drill bit 300 may be selected and entered into a design software program. Design parameters for the drill bit 300 may include, but are not limited to, the geometry of the drill bit 300 (e.g., diameter, length, profile, number of blades 310, shape of blades 310, etc.), and the types of materials used to manufacture the drill bit 300. The design software program may be a computer program stored on a non-transitory, computer-readable medium that contains program instructions configured to be executed by one or more processors of a computer system (not shown). In some embodiments, the design software program may be configured for or is otherwise supported using MATLAB® as a software platform. In other embodiments, the design software program may be configured for or supported using any other software program capable of designing and optimizing drill bits as disclosed herein. For instance, the design software program may utilize any other suitable software platform that is able to configure and manipulate the various design parameters of the drill bit 300.

Once all the design parameters are successfully entered into the design software computer program, a design model of the drill bit 300 may be generated. In some embodiments, the design model may be depicted for user interface in the form of a three-dimensional graphical representation of the drill bit 300, as illustrated in FIGS. 3A-3B. Since the overall geometry of the drill bit 300 is known, the rotational axis 312 about which the geometry of the drill bit 300 is configured to rotate may also be determined and displayed by the design software. Moreover, since the shape of the drill bit 300 and the various materials used throughout the geometry are known, one or more algorithms may be written into the design software program and configured to calculate and otherwise locate the center of mass point and/or the center of mass axis or inertia axis (not shown), as described in greater detail below. Once the inertia axis is determined, mass balancing of the drill bit 300 may be assessed and potential design modifications or solutions may be proposed or otherwise undertaken in order to generate a mass-balanced drill bit 300 where the rotational axis 312 and the inertia axis are substantially aligned.

Referring now to FIG. 4, with continued reference to FIGS. 3A-3B, illustrated is a virtual design model of a portion of the drill bit 300, according to one or more embodiments. In particular, FIG. 4 depicts a three-dimensional plot 400 of the head of the drill bit 300, as generated by the design software program described above. As illustrated, the channels 306 and the blades 310 of the drill bit 300 are representatively shown in phantom above the drill bit 300. As discussed below, various details of the plot 400 may help facilitate the determination or calculation of the true location of the inertia axis 402.

More specifically, the plot 400 may provide Cartesian coordinates in the x, y, and z directions such that the design model may be subdivided into multiple unitary volume blocks or elements 404 of known parallelepipedic or cubic dimensions. The parallelepipedic or cubic dimension of each unitary volume element 404 (hereafter “element 404”) may vary depending on the application. In some embodiments, for example, the parallelepipedic or cubic dimension may be about 0.2 mm³. In other embodiments, however, the parallelepipedic or cubic dimension of each element 404 may be more or less than 0.2 mm³, without departing from the scope of the disclosure. As will be appreciated, employing smaller parallelepipedic or cubic dimensions may result in more precise mass distribution calculations for the drill bit 300. However, configuring each element 404 with smaller parallelepipedic or cubic dimensions may also require additional elements 404 needed to make up the entire mass of the drill bit 300. As a result, the processing power of the computer running the design software program may be a limiting factor in how small the parallelepipedic or cubic dimensions for the element 404 may be.

The elements 404 may be spatially distributed over the head of the drill bit 300, as shown in FIG. 4. As a result, some of the elements 404 may be located on the blades 310, as shown in the darker shaded areas of the plot 400, and thereby accounting for densities corresponding to diamond-impregnated materials. Some of the elements 404 may be located entirely within a channel 306 between adjacent blades 310, as shown in the lighter shaded areas of the plot 400, thereby not encompassing any material or mass of the drill bit 300 but instead occupying vacuous space. Such elements 404 may account for a density equal to zero since no material is located in those areas. Similarly, some elements 404 may be located at a port 308 (FIG. 3B) or an internal drilling fluid flow path (not shown) that leads to the port 308, thereby also not encompassing any material density or mass of the drill bit 300 but instead occupying vacuous space. Some of the elements 404 may be located in the interior of the bit body 302 (FIGS. 3A and 3B), accounting for the density of the metal matrix (e.g., steel for steel bit bodies 302). Some of the elements 404 may be located in the steel blank, the shank, or the sleeve, and thereby accounting for the density of the steel at those locations. Moreover, some of the elements 404 may be located across a portion of a channel 306 and a blade 310. In such cases, the geometrical center of the parallelepipedic volume position for such elements 404 may be used to define the material density to consider.

The mass of each element 404 may be calculated or otherwise determined by knowing the location of the geometrical center of each element 404 in the plot 400 and the material with which the drill bit 300 will be made at that particular location. More specifically, the design software program may be configured to precisely locate each element 404 in the plot 400 using the x, y, and z coordinates and calculate the mass of each element 404 using the known density of the material that makes up the element 404 at its corresponding location in the plot 400 with respect to the drill bit 300. As will be appreciated, the individual masses of each element 404 may represent a portion of the overall mass of the drill bit 300 and, when added together, the total mass of the drill bit 300 may be obtained. Accordingly, the total mass (“mₜₒₜ”) of the drill bit 300 may be determined using the following equation:

mₜₒₜ=Σᵢ₌₁^{N}mᵢ Equation (2)

where i represents each element 404, m₁ is the mass of each element 404, and N is the number of elements 404 to be considered. Once the total mass of the drill bit 300 is determined using Equation (2), the location of the inertia axis 402 on the plot 400 may also be determined by calculating the mass center in the x direction (“x_{CM}”) and the mass center in the y direction (“y_{CM}”). This may be accomplished using the following equations:

$$\begin{matrix}{x}_{CM} = \frac{{\sum }_{i = 1}^{N} {m}_{i} {x}_{i}}{{m}_{tot}} & Equation ( 3 ) \\ {y}_{CM} = \frac{{\sum }_{i = 1}^{N} {m}_{i} {y}_{i}}{{m}_{tot}} & Equation ( 4 )\end{matrix}$$

where xᵢ is the position of each element 404 on the x-axis and yᵢ is the position of each element 404 on the y-axis. The corresponding results of Equations (3) and (4) provide Cartesian x and y coordinates for the location of the inertia axis 402 on the plot 400, thereby also providing the inertia axis offset 406, or the radial distance from the rotational axis 312 of the drill bit 300 to the inertia axis 404. The center of mass for the drill bit 300 may also be calculated using this same methodology.

As depicted in the plot 400, the design model of the drill bit 300 indicates a mass imbalance since the inertia axis 402 is offset from the rotational axis 312 by a linear distance corresponding to the inertia axis offset 406. As a result of such mass imbalance, a centrifugal force 408 may be generated that will tend to draw the drill bit 300 away from the rotational axis 312 in a linear direction passing through the central rotational axis 312 and the inertia axis 402. Unless the design of the drill bit 300 shown in the plot 400 is modified to reduce or eliminate the centrifugal force 408 when used at operating speeds, the resulting manufactured drill bit 300 will likely produce unwanted vibrations due to mass imbalance.

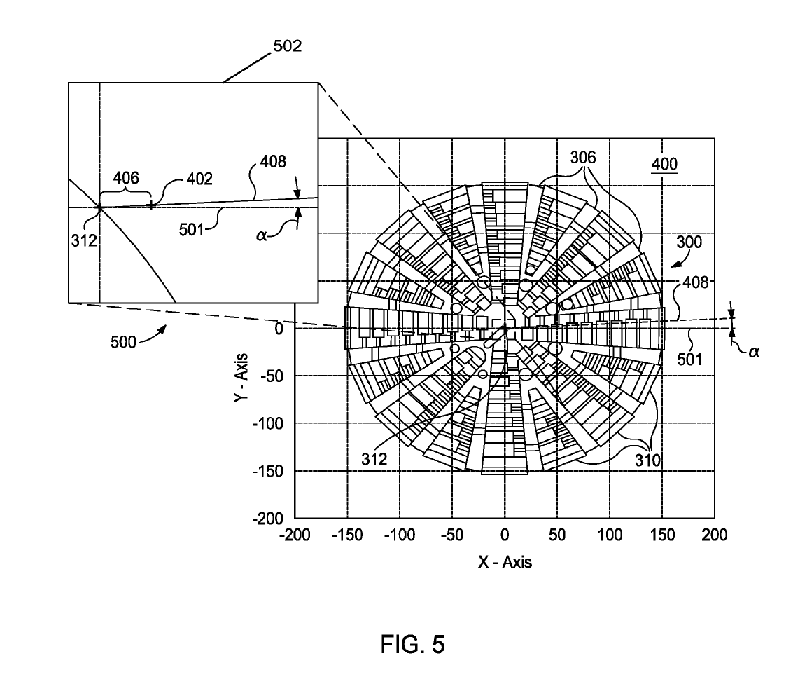

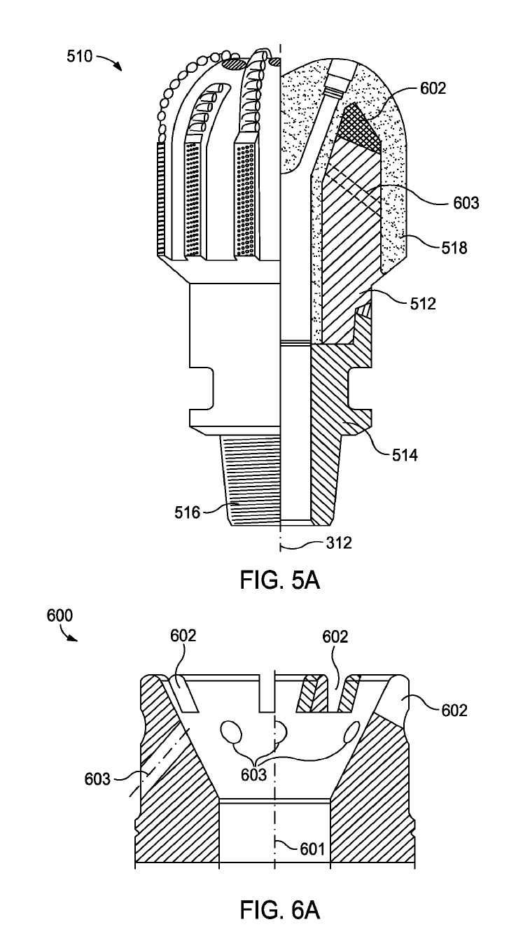

Referring now to FIG. 5, with continued reference to FIG. 4, illustrated is a plan view of the plot 400 and a corresponding enlarged view 502 of a portion of the design model of the drill bit 300, according to one or more embodiments. The magnitude of the centrifugal force 408 corresponds to a vector length and may be determined using Equation (1) above, where m is the total mass of the drill bit 300, R is the radial position of the inertia axis offset 406 with respect to the rotational axis 312, and ω is a particular angular velocity of the drill bit 300 at which it will be rotating during operation. The direction of the centrifugal force 408 is given by the angle α, from an angular reference 501.

To facilitate a better understanding of the present disclosure, the following example of calculating the centrifugal force 408 of the drill bit 300 using the design software program is provided. In no way should this example be read to limit or define the scope of the disclosure. In the illustrated example, the size of each unitary volume element 404 (FIG. 4) was 0.82 mm³ and the total mass m of the head of the drill bit 300 was calculated to be 76.65 kg. By employing Equations (3) and (4) above, the mass center in the x direction (“x_{CM}”) was calculated to be 0.226 mm and the mass center in the y direction (“y_{CM}”) was calculated to be 0.011 mm, thereby rendering an inertia axis offset 406 at 0.227 mm from the rotational axis 312. At an angular velocity ω corresponding to 1000 rpm, the resulting centrifugal force 408 (“F”) was calculated to be 190.49 Newtons (N), having an x-force component of 190.25 N and a y-force component of 9.57 N. In this example, the centrifugal force angular orientation is defined from the x-axis and taken as zero reference.

Once the center of mass position or the resulting centrifugal force F is known or otherwise calculated, including its corresponding x and y components, one or more mass balancing solutions may be undertaken or employed to modify the design model in order to facilitate the manufacturing of a mass-balanced certified drill bit. As a result, a modified design model may be generated by the design software program and the resulting drill bit may be manufactured based on the parameters provided by the modified design model. In other embodiments, one or more mass balancing solutions may be undertaken on the drill bit 300 following manufacturing, as will be discussed in greater detail below.

The various mass balancing solutions may be configured to strategically add or remove mass to/from the design model or the drill bit 300 such that the inertia axis 402 is moved to (or closer to) the rotational axis 312, thereby compensating for the centrifugal force 408. One mass balancing solution may include placing or using materials of different densities at predetermined or given locations on the body 302 of the drill bit 300 or the blades 310. For example, this may entail designing an asymmetrical steel blank such that a difference of density between the steel blank and the metal matrix of the bit body 302 results.

Another mass balancing solution may include adding or removing a balancing element to/from the design model or the drill bit 300. This could be done at the gauge pad level of the drill bit 300 or otherwise on its body 302 or shank, or eventually on a sleeve, if any is used during manufacturing. Such balancing elements may be attached to the drill bit 300 by various methods including, but not limited to, mechanical fastening (e.g., screws, bolts, etc.), brazing, welding, industrial adhesives, interference fits, shrink fitting, combinations thereof, and the like. In some embodiments, this method of adding or removing balancing elements may be done within the infiltration mold of the drill bit 300 during manufacturing or otherwise after infiltration.

Another mass balancing solution may include modifying the design of the blades 310 such that an asymmetrical blade 310 configuration or position results. Such a mass balancing solution may include designing or manufacturing blades 310 that are not symmetrical in order to displace the mass of the drill bit 300 in one quadrant (i.e., a plurality of elements 404 of FIG. 4 in a predetermined region), for example. Modifying the design of the blades 310 may further include designing or manufacturing thicker or thinner blades 310 at predetermined radial locations with respect to the rotational axis 312, or making larger blades 310 in one given angle with respect to the rotational axis 312 and thereby adding mass on one side (i.e., angular location) of the drill bit 300.

Additional mass balancing solutions may include, but are not limited to, designing nozzles or ports 308 (FIG. 3B) and/or fixed size ports of varying sizes and/or positions, modifying the shape of the hydraulic chamber (possibly including fins or other fluid obstructions, for example), and/or generating asymmetric bridge positions and diameters. Another mass balancing solution may include positioning the central axis of the steel blank used to make the drill bit 300 offset from the bit central rotational axis 312. After modification of the bit design, using one or several of the solutions described herein, the bit design can be re-run through the software program described above to re-check or verify the position of the inertia axis 204 (i.e., the center of mass).

Independent of the balancing methods and solutions described above, a manufactured drill bit can be checked for any mass unbalancing resulting from manufacturing tolerances and precision. The manufactured and tested drill bit can then be balanced by adding or removing a mass on a given radial position, such as by adding or removing one or more elements by brazing, gluing, screwing, drilling, milling, grinding or any other method. Testing methods to measure mass balancing levels are well known and encompass, for example, measuring lateral vibrations with accelerometers on the manufactured drill bit as it rotates on a lathe.

Referring briefly to FIG. 5A, for example, illustrated is a partial cross-sectional view of a matrix body drill bit 510, according to one or more embodiments. As illustrated, the matrix body drill bit 510 may include a steel blank 512 coupled or otherwise attached to a shank 514. The shank 514 may be threaded 516, as shown, such that the matrix body drill bit 510 may be attached to drill pipe (not shown), or the like. The steel blank 512 may be generally encased in a matrix material 518, such as with one of the matrix materials described herein above. The steel blank 512 may define or otherwise provide various holes 603 and slots 602. The holes 603 may be used to direct drilling fluids out of the matrix body drill bit 510, and the slots 602 may be similar to the channels 306 of FIGS. 3A and 3B.

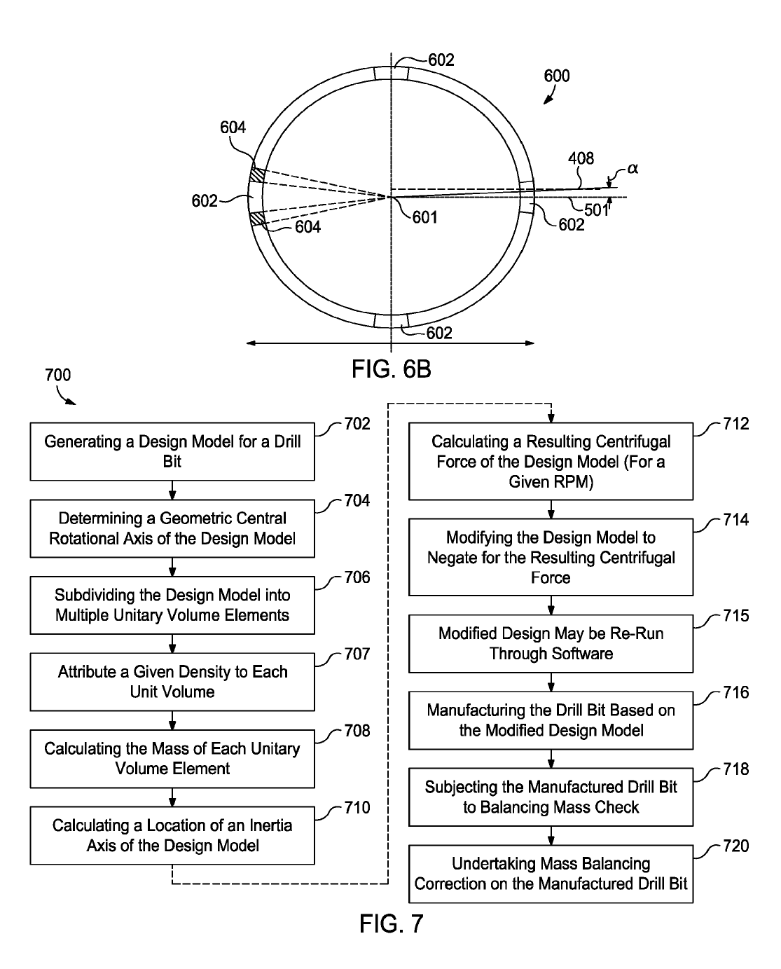

Referring now to FIGS. 6A and 6B, with continued reference to FIG. 5A, illustrated is a portion of a drill bit steel blank 600 that may have an exemplary mass balancing solution applied thereto, according to one or more embodiments. In particular, FIG. 6A depicts a partial cross-sectional view of a portion of the drill bit steel blank 600 and FIG. 6B depicts a plan section view of the drill bit steel blank 600. The drill bit steel blank 600 constitutes the core of a drill bit, such as the matrix body drill bit 510 of FIG. 5A and exhibits an axis of rotation 601. The axis of rotation 601 may be positioned in alignment with the central rotational axis (e.g., the central rotational axis 312 of FIGS. 3A and 3B). As illustrated in FIG. 6A, the drill bit steel blank 600 may include various slots 602 and/or holes 603.

According to the mass balancing solution portrayed in FIGS. 6A and 6B, the geometry of portions of one or more of the slots 602 may be enlarged or otherwise reduced in order to offset the effects of the resulting centrifugal force 408 (FIG. 6B). Similarly, the holes 603 may be enlarged, reduced, multiplied, and/or removed in given positions of the drill bit steel blank 600 in order to offset the inertial axis of the drill bit steel blank 600 as compared to the axis of rotation 601. The density of the drill bit steel blank 600 is typically lower than the density of the metal matrix of the matrix body drill bit 510. In the illustrated embodiment, additional material 604 (e.g., steel) may be added or removed to one or more of the slots 602, thereby altering the mass distribution of the drill bit steel blank 600 at that location. Alternatively, one or more additional slots 602 or holes 302 may be added to the drill bit steel blank 600 in order to achieve a symmetrical drill bit steel blank 600.

In FIGS. 6A and 6B, the additional material 604 is added to one of the slots 602 so as to reduce the area of the particular slot 602 on the drill bit steel blank 600 and thereby alter the overall mass distribution of the drill bit steel blank 600. As illustrated, the modifications to the slot 602 are angularly positioned opposite the resulting centrifugal force 408 and otherwise forming an angle with the x-axis reference of α+180°. The additional material 604 added to the slot 602 may be coupled to the drill bit steel blank 600 using various means including, but not limited to, mechanical fasteners (e.g., screws, bolts, etc.), brazing, welding, industrial adhesives, interference fits, shrink fitting, during molding, combinations thereof, and the like. In other embodiments, as will be appreciated, the size of the slot 602 may be enlarged by removing material from the drill bit steel blank 600.

Referring now to FIG. 7, illustrated is a method 700 of designing and manufacturing a mass-balanced drill bit, according to one or more embodiments. The method may include generating a design model for a drill bit, as at 702. The design model may be generated by entering one or more design parameters for the drill bit into a design software program. As mentioned above, the design software program may be a computer program stored on a non-transitory, computer-readable medium that contains program instructions configured to be executed by one or more processors of a computer system. The one or more design parameters may include the geometry of the drill bit, the shape of the drill bit, and the materials used to manufacture the drill bit. In some embodiments, generating the design model for the drill bit may include plotting the design model in a three-dimensional plot that may be viewable by an operator or user.

A geometric or rotational axis of the design model may then be determined, as at 704. The geometric or rotational axis of the design model may be determined using the software program, as discussed above. The design model may then be subdivided into multiple unitary volume elements, as at 706. In some embodiments, the entire design model may be subdivided into multiple unitary volume elements. In other embodiments, however, only certain portions of the design model may be considered and subdivided into unitary volume elements. A given density may be attributed to each unit volume, as a 707. The density of each unitary volume element may be defined and the mass of each unitary volume element may then be calculated, as at 708. Calculating the mass of each unitary volume element may include correlating a location of each unitary volume element in the three-dimensional plot generated by the design software with the materials with which the drill bit will be manufactured at each corresponding location of the unitary volume elements. Using the masses of each unitary volume element, the total mass of the design model may then be calculated.

The method 700 may further include calculating a location of an inertia axis of the design model, as at 710. In some embodiments, the inertia axis may be determined by calculating a mass center of the design model in an x direction and calculating a mass center of the design model in a y direction. As described above, the mass centers of the design model in the x and y directions may be calculated using the mass of each unitary volume element and the total mass of the design model as determined by the software program. Moreover, an inertia axis offset may be calculated from the rotational axis using the mass center of the design model in the x and y directions.

A resulting centrifugal force of the design model for a given speed of rotation (in RPM) may then be calculated, as at 712. The resulting centrifugal force may be calculated by applying a given angular velocity to the design model in conjunction with the total mass and the inertia axis of the design model. Once the resulting centrifugal force is known, the method 700 may proceed by modifying the design model to compensate for the resulting centrifugal force, as at 714. Upon modifying the design model, a modified design model results that, in some embodiments, may be re-run through the mass balancing software model, as at 715. With the modified design model, the drill bit may then be manufactured based on the modified design model, as at 716. Following manufacture, the manufactured drill bit may once again be subjected to a balancing mass check, as at 718. In the event any mass imbalances are detected or otherwise determined during the balancing mass check, mass balancing corrections may then be undertaken on the manufactured drill bit, as at 720.

In some embodiments, modifying the design model may include undertaking one or more mass balancing solutions that strategically add or remove mass to or from the design model such that the inertia axis is moved closer to or at the rotational axis. In some embodiments, the mass balancing solutions may be configured to strategically add or remove mass to or from the drill bit itself following manufacturing. As generally described above, one or more mass balancing solutions may include, but are not limited to virtually placing materials of different densities at predetermined locations on the design model, virtually adding or removing a balancing element to or from the design model, virtually modifying a design of the one or more blades such that at least one asymmetrical blade configuration results, and designing at least one of nozzles or ports of a variable size or position. In other embodiments, undertaking a mass balancing solution may include adding one or more blade extensions to at least one or more of the blades of the drill bit and thereby altering the mass distribution of the drill bit at that location.

Computer hardware used to implement the various methods and algorithms described herein can include a processor configured to execute one or more sequences of instructions, programming stances, or code stored on a non-transitory, computer-readable medium. The processor can be, for example, a general purpose microprocessor, a microcontroller, a digital signal processor, an application specific integrated circuit, a field programmable gate array, a programmable logic device, a controller, a state machine, a gated logic, discrete hardware components, an artificial neural network, or any like suitable entity that can perform calculations or other manipulations of data. In some embodiments, computer hardware can further include elements such as, for example, a memory (e.g., random access memory (RAM), flash memory, read only memory (ROM), programmable read only memory (PROM), electrically erasable programmable read only memory (EEPROM)), registers, hard disks, removable disks, CD-ROMS, DVDs, or any other like suitable storage device or medium.

Executable sequences described herein can be implemented with one or more sequences of code contained in a memory. In some embodiments, such code can be read into the memory from another machine-readable medium. Execution of the sequences of instructions contained in the memory can cause a processor to perform the process steps described herein. One or more processors in a multi-processing arrangement can also be employed to execute instruction sequences in the memory. In addition, hard-wired circuitry can be used in place of or in combination with software instructions to implement various embodiments described herein. Thus, the present embodiments are not limited to any specific combination of hardware and/or software.

As used herein, a machine-readable medium refers to any medium that directly or indirectly provides instructions to a processor for execution. A machine-readable medium can take on many forms including, for example, non-volatile media, volatile media, and transmission media. Non-volatile media can include, for example, optical and magnetic disks. Volatile media can include, for example, dynamic memory. Transmission media can include, for example, coaxial cables, wire, fiber optics, and wires that form a bus. Common forms of machine-readable media can include, for example, floppy disks, flexible disks, hard disks, magnetic tapes, other like magnetic media, CD-ROMs, DVDs, other like optical media, punch cards, paper tapes and like physical media with patterned holes, RAM, ROM, PROM, EPROM and flash EPROM.

Embodiments disclosed herein include:

A. A method of manufacturing a mass-balanced drill bit that includes generating a design model for a drill bit, the design model including one or more blades and one or more channels that are included in the drill bit, determining a rotational axis of the design model, dividing the design model into a plurality of unitary volume parallelepipedic elements distributed over at least a portion of the design model, determining a material density and mass of each unitary volume parallelepipedic element and using the material density and mass of each unitary volume parallelepipedic element to calculate a total mass of the design model, calculating a location of an inertia axis of the design model, determining a resulting centrifugal force of the design model upon applying a given angular velocity to the design model and using at least a portion of the total mass and the inertia axis, and modifying the design model to compensate for the resulting centrifugal force and thereby generating a modified design model.

B. A mass-balanced drill bit that includes a drill bit based on a design model and having a body with one or more blades and one or more channels defined therein, the drill bit exhibiting a rotational axis based on a geometry of the drill bit, and a center of mass projected on a plane perpendicular to the bit rotational axis and an inertia axis of the drill bit as determined by the design model and based on a distributed mass over at least a portion of the drill bit, wherein the design model is modified such that the center of mass or the inertia axis is aligned with the rotational axis to reduce vibrations of the drill bit.

Each of embodiments A and B may have one or more of the following additional elements in any combination: Element 1: wherein generating the design model for the drill bit comprises entering one or more design parameters for the drill bit into a design software program, wherein the design software program is a computer program stored on a non-transitory, computer-readable medium that contains program instructions configured to be executed by one or more processors of a computer system. Element 2: wherein the one or more design parameters include the geometry of the drill bit, the shape of the drill bit, and the materials used to manufacture the drill bit. Element 3: wherein generating the design model for the drill bit comprises plotting the design model in a three-dimensional grid plot. Element 4: wherein determining the material density and mass of each unitary volume parallelepipedic element comprises correlating a location of each unitary volume parallelepipedic element in the grid plot with one or more materials with which the drill bit will be manufactured at each corresponding location. Element 5: wherein calculating the location of the center of mass point and/or the inertia axis of the design model comprises calculating a center of mass of the design model in an x direction, and calculating a center of mass of the design model in a y direction, wherein the centers of mass of the design model in the x and y directions are calculated using the mass of each unitary volume parallelepipedic element and the total mass of the design model. Element 6: further comprising calculating a center of mass or an inertia axis offset from the rotational axis using the center of mass of the design model in the x and y directions. Element 7: wherein modifying the design model to compensate for the resulting centrifugal force comprises undertaking one or more mass balancing solutions that strategically add or remove mass to or from the design model such that the inertia axis is moved closer to the rotational axis. Element 8: wherein undertaking one or more mass balancing solutions comprises at least one of placing materials of different densities at predetermined locations on the design model, adding or removing a balancing element to or from the design model, modifying a design of the one or more blades such that at least one asymmetrical blade configuration results, and designing at least one of nozzles and nozzle ports of a variable size or position. Element 9: wherein undertaking one or more mass balancing solutions comprises adding one or more blade extensions to at least one of the one or more blades and thereby altering mass properties of the drill bit at that location.

Element 10: wherein the design model is based on one or more design parameters for the drill bit as entered into a design software program stored on a non-transitory, computer-readable medium that contains program instructions configured to be executed by one or more processors of a computer system. Element 11: wherein the one or more design parameters include the geometry of the drill bit, the shape of the drill bit, and the materials used to manufacture the drill bit. Element 12: wherein the design model determines a resulting centrifugal force based on the given angular velocity and allows modifications to the design model in order to negate the resulting centrifugal force. Element 13: wherein the design model for the drill bit is plotted in a three-dimensional grid plot. Element 14: wherein the design model is subdivided into multiple unitary volume parallelepipedic elements distributed over at least a portion of the design model. Element 15: wherein the mass of each unitary volume parallelepipedic element is calculated by correlating a location of each unitary volume parallelepipedic element in the grid plot with a material density with which the drill bit will be manufactured at each corresponding location. Element 16: wherein a location of the inertia axis of the design model is determined by calculating a center of mass of the design model in an x direction and a y direction, wherein the centers of mass of the design model in the x and y directions are calculated using the mass of each unitary volume parallelepipedic element and calculated partial or total mass of the design model. Element 17: further comprising an inertia axis offset calculated from the rotational axis using the center of mass of the design model in the x and y directions. Element 18: wherein the design model is modified by undertaking one or more mass balancing solutions that strategically add or remove mass to or from the design model such that the center of mass and the inertia axis are moved to the rotational axis. Element 19: wherein the one or more mass balancing solutions comprises at least one of placing materials of different densities at predetermined locations on the design model, adding or removing a balancing element to or from the design model, modifying a design of the one or more blades such that at least one asymmetrical blade configuration results, and designing at least one of nozzles and nozzle ports of a variable size or position. Element 20: wherein the one or more mass balancing solutions comprises adding one or more blade extensions to at least one of the one or more blades and thereby altering mass properties of the drill bit at that location.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

What is claimed is:

1. A method, comprising:
generating a design model for a drill bit, the design model including one or more blades and one or more channels that are included in the drill bit;
determining a rotational axis of the design model;
dividing the design model into a plurality of unitary volume parallelepipedic elements distributed over at least a portion of the design model;
determining a material density and mass of each unitary volume parallelepipedic element and using the material density and mass of each unitary volume parallelepipedic element to calculate a total mass of the design model;
calculating a location of an inertia axis of the design model;
determining a resulting centrifugal force of the design model upon applying a given angular velocity to the design model and using at least a portion of the total mass and the inertia axis; and
modifying the design model to compensate for the resulting centrifugal force and thereby generating a modified design model.

2. The method of claim 1, wherein generating the design model for the drill bit comprises entering one or more design parameters for the drill bit into a design software program, wherein the design software program is a computer program stored on a non-transitory, computer-readable medium that contains program instructions configured to be executed by one or more processors of a computer system.

3. The method of claim 2, wherein the one or more design parameters include the geometry of the drill bit, the shape of the drill bit, and materials used to manufacture the drill bit.

4. The method of claim 1, wherein generating the design model for the drill bit comprises plotting the design model in a three-dimensional grid plot.

5. The method of claim 4, wherein determining the material density and mass of each unitary volume parallelepipedic element comprises correlating a location of each unitary volume parallelepipedic element in the grid plot with one or more materials with which the drill bit will be manufactured at each corresponding location.

6. The method of claim 1, wherein calculating the location of the inertia axis of the design model comprises:
calculating an x direction center of mass of the design model; and
calculating a y direction center of mass of the design model, wherein the x and y direction centers of mass are calculated using the mass of each unitary volume parallelepipedic element and the total mass of the design model.

7. The method of claim 6, further comprising calculating an inertia axis offset from the rotational axis using the x and y direction centers of mass of the design model.

8. The method of claim 1, wherein modifying the design model to compensate for the resulting centrifugal force comprises undertaking one or more mass balancing solutions that add or remove mass to or from the design model such that the inertia axis is moved closer to the rotational axis.

9. The method of claim 8, wherein undertaking the one or more mass balancing solutions comprises at least one of placing materials of different densities at predetermined locations on the design model, adding or removing a balancing element to or from the design model, modifying a design of the one or more blades, and designing a nozzle or a nozzle port of a variable size or position in the design model.

10. The method of claim 8, wherein undertaking the one or more mass balancing solutions comprises adding one or more blade extensions to at least one of the one or more blades.

11. A mass-balanced drill bit, comprising:
a drill bit based on a design model and having a body that includes one or more blades and one or more channels defined between adjacent blades, the drill bit exhibiting a rotational axis based on a geometry of the drill bit; and
a center of mass projected on a plane perpendicular to the bit rotational axis and an inertia axis of the drill bit as determined by the design model and based on a distributed mass over at least a portion of the drill bit, wherein the design model is modified such that the inertia axis is aligned with the rotational axis to reduce vibrations of the drill bit.

12. The mass-balanced drill bit of claim 11, wherein the design model is based on one or more design parameters for the drill bit as entered into a design software program stored on a non-transitory, computer-readable medium that contains program instructions configured to be executed by one or more processors of a computer system.

13. The mass-balanced drill bit of claim 12, wherein the one or more design parameters include the geometry of the drill bit, the shape of the drill bit, and materials used to manufacture the drill bit.

14. The mass-balanced drill bit of claim 11, wherein the design model determines a resulting centrifugal force based on a given angular velocity and allows modifications to the design model in order to negate the resulting centrifugal force.

15. The mass-balanced drill bit of claim 11, wherein the design model for the drill bit is plotted in a three-dimensional grid plot.

16. The mass-balanced drill bit of claim 15, wherein the design model is subdivided into a plurality of unitary volume parallelepipedic elements distributed over at least a portion of the design model.

17. The mass-balanced drill bit of claim 16, wherein the mass of each unitary volume parallelepipedic element is calculated by correlating a location of each unitary volume parallelepipedic element in the grid plot with a material density with which the drill bit will be manufactured at each corresponding location.

18. The mass-balanced drill bit of claim 16, wherein a location of the inertia axis of the design model is determined by calculating a center of mass of the design model in an x direction and a y direction, wherein the centers of mass of the design model in the x and y directions are calculated using the mass of each unitary volume parallelepipedic element and calculated partial or total mass of the design model.

19. The mass-balanced drill bit of claim 18, further comprising an inertia axis offset calculated from the rotational axis using the center of mass of the design model in the x and y directions.

20. The mass-balanced drill bit of claim 11, wherein the design model is modified by undertaking one or more mass balancing solutions that add or remove mass to or from the design model such that the inertia axis is moved to the rotational axis.

21. The mass-balanced drill bit of claim 20, wherein the one or more mass balancing solutions comprise at least one of placing materials of different densities at predetermined locations on the design model, adding or removing a balancing element to or from the design model, modifying a design of the one or more blade, and designing at least one of nozzles and nozzle ports of a variable size or position.

22. The mass-balanced drill bit of claim 20, wherein the one or more mass balancing solutions comprises adding one or more blade extensions to at least one of the one or more blades.
